(19) United States
(12) Patent Application Publication
(10) Pub. No.: US 2024/0234985 A1
(43) Pub. Date: Jul. 11, 2024

(54) BUTTON TYPE SECONDARY BATTERY

(71) Applicant: LG ENERGY SOLUTION, LTD., Seoul (KR)

(72) Inventors: Min Gyu KIM, Daejeon (KR); Joo Hwan SUNG, Daejeon (KR); Min Su CHO, Daejeon (KR); Geun Young PARK, Daejeon (KR)

(73) Assignee: LG ENERGY SOLUTION, LTD., Seoul (KR)

(21) Appl. No.: 18/561,631

(22) PCT Filed: Jul. 8, 2022
(86) PCT No.: PCT/KR2022/009975

§ 371 Date: Nov. 16, 2023

(30) Foreign Application Priority Data
Jul. 12, 2021 (KR) 10-2021-0091247

(51) Int. Cl. H01M 50/59; H01M 10/04; H01M 10/42; H01M 50/109; H01M 50/169; H01M 50/559; H01M 50/586

(52) U.S. Cl. CPC H01M 50/59; H01M 10/0431; H01M 10/4235; H01M 50/109; H01M 50/169; H01M 50/559; H01M 50/586

(57) ABSTRACT

A disclosed button type secondary battery having a diameter greater than a height thereof may include: an electrode assembly, in which electrodes and separators are alternately disposed; a can body into which the electrode assembly is inserted; a base plate in which a through-hole is formed and which covers an opening of an upper end of the can body and is bonded to the can body; an electrode terminal of which at least a portion is inserted into the through-hole of the base plate and which covers the through-hole; an insulating gasket configured to insulate the electrode terminal and the base plate from each other; an insulating sheet disposed on a bottom surface of the base plate to insulate the base plate and the electrode assembly from each other; and a shield member disposed on an upper end of an edge portion of the electrode assembly.

### TECHNICAL FIELD

### Cross-Reference to Related Application

The present application claims the benefit of the priority of Korean Patent Application No. 10-2021-0091247, filed on Jul. 12, 2021, which is hereby incorporated by reference in its entirety.

### TECHNICAL FIELD

The present invention relates to a button type secondary battery, and more particularly, to a button type secondary battery, in which since there is an effect of pressing a separator of an electrode assembly downward so as to be gathered inward, the separator ascends to be prevented from interfering with a laser-welded portion between a can body and a base plate, and the electrode assembly is pressed downward to improve fixability, thereby preventing the electrode assembly from being shaken in a cell.

### BACKGROUND ART

In recent years, the price of energy sources increases due to the depletion of fossil fuels, the interest in environmental pollution is amplified, and the demand for eco-friendly alternative energy sources is becoming an indispensable factor for future life. Accordingly, studies on various power generation technologies, such as solar power, wind power, and tidal power, are continuing, and power storage devices, such as batteries, for more efficiently using the generated electrical energy are also of great interest.

Furthermore, as technology development and demand for electronic mobile devices and electric vehicles using batteries increase, the demands for batteries as energy sources are rapidly increasing. Thus, many studies on batteries which are capable of meeting various demands have been conducted.

In particular, in terms of materials, there is a high demand for lithium secondary batteries, such as lithium ion batteries and lithium ion polymer batteries, having such advantages as high energy density, discharge voltage, and output stability.

The secondary batteries may be classified into, among others, cylindrical batteries and prismatic batteries, in which an electrode assembly is embedded in a cylindrical or prismatic metal can, and pouch-type batteries, in which an electrode assembly is embedded in a pouch-type case made of an aluminum laminate sheet, according to shapes of battery cases. Also, recently, due to the trend of smaller wearable devices, the importance of developing small batteries, such as button type secondary batteries, has been highlighted.

In the button cell, after the electrode assembly is inserted into the can body that is a battery can case, a base plate that is a cover having a plate shape is covered on an opening of the can body, and the can body and the base plate are laser-welded to each other. However, in the conventional button cell, there is a problem in that the separator of the electrode assembly ascends to the laser-welded portion between the can body and the base plate to cause an interference during the laser welding. This leads to defective products, which frequently occur because the button cell has a very small size.

In addition, the button cell used in such a wearable device may be inevitably shaken much more during the use process. In this case, the conventional button cell has a problem in that the electrode assembly is shaken together inside the button cell. As described above, when the electrode assembly is shaken, there is a problem in that a portion, at which an electrode tab connected to an electrode of the electrode assembly is welded, to a can is easily separated to cause failure of a product.

### DISCLOSURE OF THE INVENTION

### Technical Objective

The present invention has been devised to solve the above problems, and an object of the present invention is to provide a button type secondary battery, in which since there is an effect of pressing a separator of an electrode assembly downward so as to be gathered inward, the separator ascends to be prevented from interfering with a laser-welded portion between a can body and a base plate, and the electrode assembly is pressed downward to improve fixability, thereby preventing the electrode assembly from being shaken in a cell.

### Technical Solution

A button type secondary battery according to the present invention relates to a button type secondary battery having a diameter greater than a height thereof, the button type secondary battery including: an electrode assembly, in which electrodes and separators are alternately disposed; a can body into which the electrode assembly is inserted; a base plate in which a through-hole is formed and which covers an opening of an upper end of the can body and is bonded to the can body; an electrode terminal of which at least a portion is inserted into the through-hole of the base plate and which covers the through-hole; an insulating gasket configured to insulate the electrode terminal and the base plate from each other; an insulating sheet disposed on a bottom surface of the base plate to insulate the base plate and the electrode assembly from each other; and a shield member disposed on an upper end of an edge portion of the electrode assembly.

An edge of the base plate and the opening of the can body may be bonded to each other by laser welding.

The electrode terminal, the insulating gasket, and the base plate may be bonded to each other through thermal fusion.

The shield member may be disposed between an upper end of the outermost separator and a welding part, which is a portion coupled by laser welding, in the electrode assembly.

The shield member may be provided as an insulator.

The shield member may include a ring-shaped structure.

The shield member may have an inner surface formed in an oblique line based on a cross-sectional view.

The shield member may have a right-angled triangular cross-section, and in a cross-sectional view, a right-angled corner of a right-angled triangle may be disposed at a corner portion at which the can body and the base plate meet each other at a right angle.

The shield member may be fixed without being shaken.

The electrode terminal may have a positive pole, and each of the can body and the base plate may have a negative pole.

A coating layer including a material that blocks heat may be formed on a surface of the shield member, which faces the electrode assembly.

The material that blocks the heat may include ceramic.

The electrode assembly may include an electrode wound body, in which one or more positive electrodes, one or more negative electrodes, and one or more separators are wound on each other.

### Advantageous Effects

The button type secondary battery according to the present invention may include the electrode assembly, in which the electrodes and the separators are alternately disposed, the can body into which the electrode assembly is inserted, the base plate in which the through-hole is formed and which covers the opening of the upper end of the can body and is bonded to the can body, the electrode terminal of which at least a portion is inserted into the through-hole of the base plate and which covers the through-hole, the insulating gasket configured to insulate the electrode terminal and the base plate from each other, the insulating sheet disposed on the bottom surface of the base plate to insulate the base plate and the electrode assembly from each other, and the shield member disposed on the upper end of the edge portion of the electrode assembly. Therefore, since there is an effect of pressing the separator of the electrode assembly downward so as to be gathered inward, the separator may ascend to be prevented from interfering with the laser-welded portion between the can body and the base plate, and the electrode assembly may be pressed downward to improve the fixability, thereby preventing the electrode assembly from being shaken in the cell.

### BRIEF DESCRIPTION OF THE DRAWINGS

FIG. 1 is a cross-sectional view of a button type secondary battery according to Embodiment 1 of the present invention.

FIG. 2 is a cross-sectional view of a button type secondary battery according to Embodiment 2 of the present invention.

### MODES FOR CARRYING OUT THE INVENTION

Hereinafter, preferred example embodiments of the present invention will be described in detail with reference to the accompanying drawings so that those of ordinary skill in the art can easily carry out the present invention. However, the present invention may be implemented in several different forms and is not limited or restricted by the following examples.

In order to clearly explain the present invention, detailed descriptions of portions that are irrelevant to the description or related known technologies that may unnecessarily obscure the gist of the present invention have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

### Embodiment 1

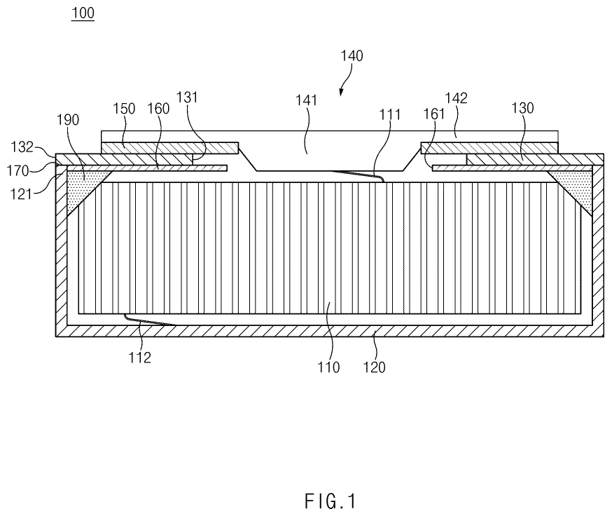

FIG. 1 is a cross-sectional view of a button type secondary battery according to Embodiment 1 of the present invention.

With reference to FIG. 1, a button type secondary battery 100 according to Embodiment 1 of the present invention may be a button-type secondary battery 100 of which a diameter is greater than a height. Also, the button type secondary battery 100 according to Embodiment 1 of the present invention may include an electrode assembly 110, a can body 120, a base plate 130, an electrode terminal 140, an insulating gasket 150, and an insulating sheet 160.

The electrode assembly 110 may be formed by disposing a positive electrode, a separator, and a negative electrode. The electrode assembly 110 may be a jelly roll-type electrode assembly 110 in which the electrodes and the separator are alternately disposed and wound. The electrode assembly 110 may be an electrode wound body in which one or more positive electrodes, one or more negative electrodes, and one or more separators are wound on each other.

The can body 120 may have a configuration in which the electrode assembly 110 is inserted. The can body 120 may have an internal space, and the electrode assembly 110 may be vertically inserted into the internal space. The vertical insertion may mean that the electrode assembly is inserted so that a winding axis of the electrode assembly is perpendicular to a bottom part of the can body. The can body 120 may have an opening at an upper side thereof. That is, the can body 120 may be opened upward and include a bottom part and a sidewall.

The base plate 130 may cover an upper opening 121 of the can body 120 and be bonded to the can body 120. This bonding may be bonding using welding. Particularly, an edge 132 of the base plate and the opening 121 of the can body may be bonded to each other by laser welding. A portion at which the edge 132 of the base plate and the opening 121 of the can body are welded by welding may be a welding part 170.

Also, this type of laser welding may be seam welding that is advantageous for preventing a welding pin hole. In addition, a through-hole 131 may be formed in an inner center of the base plate 130. Here, the base plate may be made of a metal material, and the metal material may be at least one or more selected from SUS, nickel-plated carbon steel, and Al.

The electrode terminal 140 may be a terminal bonded to the through-hole 131 formed inside the base plate 130. The electrode terminal 140 may be a positive electrode terminal having a positive pole. This may be a result of the positive electrode of the electrode assembly 110 being connected to the electrode terminal 140. FIG. 1 illustrates a state in which the positive electrode tab 111 is connected to a bottom surface of the electrode terminal 140. This bonding may be bonding using the welding.

When the electrode terminal 140 has the positive pole, each of the can body 120 and the base plate 130 may have a negative pole. The negative electrode of the electrode assembly 110 may be connected to the can body 120 so that the can body 120 has the negative pole. As the base plate 130 is welded to the can body 120, the same negative pole as the can body 120 may be formed. FIG. 1 illustrates a state in which the negative electrode tab 112 is connected to the bottom surface of the electrode terminal 140. This bonding may be bonding using the welding.

At least a portion of the electrode terminal may be configured to be inserted into the through-hole 131 formed inside the base plate 130 so as to cover the through-hole 131. The electrode terminal 140 may be made of a metal material, and the metal material may be any one or more selected from SUS, nickel-plated carbon steel, and Al.

The insulating gasket 150 may be configured to insulate the electrode terminal 140 from the base plate 130. That is, the insulating gasket 140 may be configured to prevent short circuit from occurring between the electrode terminal 140 and the base plate 130. When the electrode terminal 140 has the positive pole, since the base plate 130 bonded to the body of the can body 120 that has a negative pole has a negative pole, and the electrode terminal 40 has a positive pole, a structure that insulates the electrode terminal 140 from the base plate is required. The structure is an insulating gasket 150.

In addition, the electrode terminal 140, the insulating gasket 150, and the base plate 130 may be bonded to each other by thermal fusion. In the related art, a rivet structure is used to couple the electrode terminal 140. However, in the button type secondary battery 100 according to Embodiment 1 of the present invention, a thermal fusion structure instead of the rivet structure may be used.

The insulating sheet 160 may be disposed on a bottom surface of the base plate 130 and may be configured to insulate the base plate 130 and the electrode assembly 110 from each other.

In addition, the insulating sheet 160 may be attached to the bottom surface of the base plate 130. When attached as described above, the insulating sheet 160 may be stably disposed without moving.

With reference to FIG. 1, the button-type secondary battery according to Embodiment 1 of the present invention may include a shield member 190. The shield member 190 may be configured to be disposed at an upper end of an edge of the electrode assembly 110.

The shield member 190 may be disposed between an upper end of the outermost separator and the welding part 170, which is a portion coupled by the laser welding, in the electrode assembly 110. The shield member 190 may be provided as an insulator. As the shield member 190 has this configuration, the separator of the electrode assembly 110 may ascend to be prevented from interfering with the laser-welded portion between the can body 120 and the base plate 130.

Specifically, in the button-type secondary battery 100 according to Embodiment 1 of the present invention, the shield member 190 may be a ring-shaped structure. That is, the electrode assembly 110 may have a cylindrical shape, and the shield member 190 may have a three-dimensional ring shape to be disposed on an edge area of an upper end of the cylindrical shape.

Also, as illustrated in FIG. 1, the shield member 190 may have an inner surface formed in an oblique line based on a cross-sectional view. Thus, the shield member may have an effect of pressing the separator of the electrode assembly 110 downward so as to be gathered inward, and thus, the separator may ascend to be more effectively prevented from interfering with a laser welded portion between the can body 120 and the base plate 130.

In addition, the shield member 190 has an effect of pressing an upper end of the separator of the electrode assembly 110 downward so that a bottom surface of the electrode assembly 110 is in close contact with a bottom surface of the can body 120. Therefore, fixability of the electrode assembly 110 may be improved

As described above, in the button type secondary battery 100 according to Embodiment 1 of the present invention, the electrode assembly 110 may be pressed downward to improve the fixability, thereby preventing the electrode assembly 110 from being shaken inside the cell. Therefore, stability and safety of the button type secondary battery 100 may be secured, and also, the welded portion of the electrode tab (the positive electrode tab 111 or the negative electrode tab 112) may not be separated.

In addition, for the stable fixing effect of the shield member 190, the shield member 190 may have a right-angled triangular cross-section. In the cross-sectional view of FIG. 1, a right-angled corner of a right-angled triangle may be disposed at a corner portion at which the can body 120 and the base plate 130 meet each other at a right angle.

In addition, for more effective fixing, a surface forming the right-angled corner of the shield member 190 may be attached to at least one surface of the can body 120 or the base plate 130. If being attached, the shield member 190 may be fixed more stably without being shaken.

In more detail, in the button type secondary battery 100 according to Embodiment 1 of the present invention, the electrode terminal 140 may include an insertion part 141 inserted into the through-hole 131 and a terminal plate part 142 extending outward from an upper end of the insertion part 141 and extending to have a plate shape.

Here, the insertion part 141 may have a shape of which a cross-sectional diameter gradually decreases as the insertion part 141 descends in a direction closer to the electrode assembly 110. An insertion hole 161 may be formed inside the insulating sheet 160. In this case, a lower end of the insertion part 141 may be inserted into the insertion hole 161 of the insulating sheet 160. When having such a structure, the lower end of the insertion part 141 may not be in contact with the insulating sheet 160. That is, the lower end of the insertion part 141 may not touch or press the insulating sheet 160, and thus, the insulating sheet 160 may be stably attached to the base plate 130.

In the button type secondary battery 100 according to Embodiment 1 of the present invention, the insulating sheet 160 may be attached to the entire surface of the bottom surface of the base plate 130 facing the electrode assembly 110.

### Embodiment 2

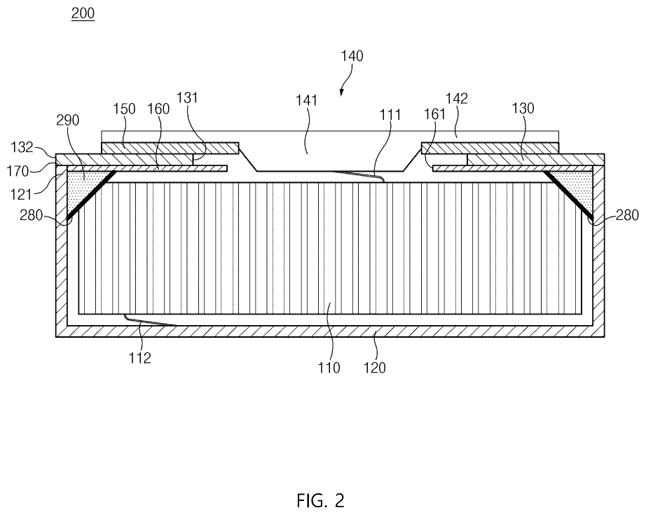

FIG. 2 is a cross-sectional view of a button type secondary battery according to Embodiment 2 of the present invention.

Embodiment 2 of the present invention is different from Embodiment 1 in that a coating layer 280 including a material for blocking heat is formed on a bottom surface of a shield member 290.

The contents that are duplicated with Embodiment 1 will be omitted as much as possible, and Embodiment 2 will be described with a focus on the differences. That is, it is obvious that contents that are not described in Embodiment 2 may be regarded as the contents of Embodiment 1 if necessary.

With reference to FIG. 2, a button-type secondary battery 200 according to Embodiment 2 of the present invention may the shield member 290, and the coating layer 280 including the material that blocks the heat may be formed on a surface of the shield member 290, which faces an electrode assembly 110. Here, the material for blocking the heat, which is provided in the coating layer 280, may be ceramic. For example, the ceramic coating layer 280 may be formed on a bottom surface of the shield member 290.

When formed in this structure, the shield member 290 may be protected even when high-temperature heat is generated inside the button type secondary battery 200. That is, even when the high-temperature heat is generated, the shield member 290 may not be melted or be damaged. Therefore, stability of the battery may be secured.

While the example embodiments of the present invention have been described with reference to the specific example embodiments, it will be apparent to those skilled in the art that various changes and modifications may be made without departing from the spirit and scope of the invention as defined in the following claims.

### DESCRIPTION OF THE SYMBOLS

100, 200: Button type secondary battery
110: Electrode assembly
111: Positive electrode tab
112: Negative electrode tab
120: Can body
121: Opening of can body
130: Base plate
131: Through-hole
132: Edge of base plate
140: Electrode terminal
141: Insertion part
142: Terminal plate part
150: Insulating gasket
160: Insulating sheet
161: Insertion hole
170: Welding part
280: Coating layer
190, 290: Shield member

1. A button type secondary battery having a diameter greater than a height thereof, the button type secondary battery comprising:
an electrode assembly, in which a plurality of electrodes and one or more separators are alternately disposed;
a can body housing the electrode assembly;
a base plate including a through-hole and covering an opening at an upper end of the can body, the base plate being bonded to the can body;
an electrode terminal covering the through-hole of the base plate, at least a portion of the electrode terminal being inserted into the through-hole of the base plate;
an insulating gasket configured to insulate the electrode terminal and the base plate from each other;
an insulating sheet disposed on a bottom surface of the base plate to insulate the base plate and the electrode assembly from each other; and
a shield member disposed between an upper end of an edge portion of the electrode assembly and at least one of the can body and the base plate.

2. The button type secondary battery of claim 1, wherein an edge of the base plate and the upper end of the can body are bonded to each other by laser welding.

3. The button type secondary battery of claim 1, wherein the electrode terminal, the insulating gasket, and the base plate are bonded to each other through thermal fusion.

4. The button type secondary battery of claim 2, wherein the shield member is disposed between an upper end of an outermost separator among the one or more separators and a welding part, which is a portion of the base plate and the upper end of the can body coupled by laser welding.

5. The button type secondary battery of claim 1, wherein the shield member is an insulator.

6. The button type secondary battery of claim 1, wherein the shield member has a ring-shaped structure.

7. The button type secondary battery of claim 1, wherein the shield member has an inner surface at an oblique line with respect to an upper surface or a lateral surface of the electrode assembly in a cross-sectional view.

8. The button type secondary battery of claim 1, wherein:
the shield member has a right-angled triangular cross-section, and
in a cross-sectional view, a right-angled corner of the shield member is disposed at a corner portion at which the can body and the insulating sheet meet each other at a right angle.

9. The button type secondary battery of claim 1, wherein the shield member is fixed between the upper end of the edge portion of the electrode assembly and a corner where the can body and the insulating sheet meet.

10. The button type secondary battery of claim 1, wherein:
the electrode terminal has a positive polarity, and
each of the can body and the base plate has a negative polarity.

11. The button type secondary battery of claim 1, further comprising a coating layer on a surface of the shield member facing the electrode assembly, the coating layer comprising a material for blocking heat.

12. The button type secondary battery of claim 11, wherein the material for blocking heat comprises ceramic.

13. The button type secondary battery of claim 1, wherein the electrode assembly comprises an electrode wound body, in which one or more positive electrodes and one or more negative electrodes among the plurality of electrodes and the one or more separators are wound on each other.

14. The button type secondary battery of claim 11, wherein the surface of the shield member facing the electrode assembly is oblique to an upper surface or a lateral surface of the electrode assembly in a cross-sectional view.
